(19) United States
(12) Patent Application Publication
(10) Pub. No.: US 2025/0046969 A1
(43) Pub. Date: Feb. 6, 2025

(54) SECONDARY BATTERY

(71) Applicant: Samsung SDI Co., Ltd., Yongin-si (KR)

(72) Inventor: Hyun Soo LEE, Yongin-si (KR)

(21) Appl. No.: 18/921,807

(22) Filed: Oct. 21, 2024

Related U.S. Application Data
(63) Continuation of application No. 18/046,621, filed on Oct. 14, 2022.

(30) Foreign Application Priority Data
Dec. 13, 2021 (KR) 10-2021-0177635

(51) Int. Cl. H01M 50/566; H01M 50/148; H01M 50/536

(52) U.S. Cl. CPC H01M 50/566; H01M 50/154; H01M 50/536

(57) ABSTRACT

A secondary battery includes: an electrode assembly including uncoated portion tabs, each protruding in a lateral direction; a sub-plate welded to the uncoated portion tabs; a current collector member electrically connected to the sub-plate; a case having an opening in the lateral direction and coupling the electrode assembly through the opening; a side terminal welded on the current collector member; and a cap plate through which the side terminal passes, the cap plate coupled to the opening.

### CROSS-REFERENCE TO RELATED APPLICATION

This application is a continuation of U.S. patent application Ser. No. 18/046,621, filed on Oct. 14, 2022, which claims priority to and the benefit of Korean Patent Application No. 10-2021-0177635, filed on Dec. 13, 2021, in the Korean Intellectual Property Office, the entire contents of both of which are herein incorporated by reference.

### BACKGROUND

### 1. Field

Aspects of embodiments of the present disclosure relate to a secondary battery.

### 2. Description of the Related Art

Unlike a primary battery that cannot be charged, a secondary battery is a rechargeable and dischargeable battery. A low-capacity secondary battery comprised of one single cell packaged in the form of a pack may be used for various portable small-sized electronic devices, such as cellular phones or camcorders, and a high-capacity secondary battery in which several tens of cells are connected in a battery pack is widely used as a power source for motor drives, such as those in hybrid vehicles or electric vehicles.

The secondary battery may be configured by incorporating into a case an electrode assembly provided by interposing a separator between a positive electrode and a negative electrode, and an electrolyte, and installing a cap plate on the case. Here, a representative example of the electrode assembly may be a winding type or a stack type.

The above information disclosed in this Background section is provided for enhancement of understanding of the background of the invention and, therefore, it may contain information that does not constitute prior art.

### SUMMARY

According to an aspect of embodiments of the present disclosure, a secondary battery having a side terminal is provided.

According to one or more embodiments, a secondary battery includes: an electrode assembly including uncoated portion tabs, each protruding in a lateral direction; a sub-plate welded to the uncoated portion tabs; a current collector member electrically connected to the sub-plate; a case having an opening in the lateral direction and coupling the electrode assembly through the opening; a side terminal welded on the current collector member; and a cap plate through which the side terminal passes, the cap plate coupled to the opening.

In one or more embodiments, a thickness of the current collector member may be larger than a thickness of the side terminal.

In one or more embodiments, the side terminal may include: a hollow type rivet penetrating through the cap plate and welded on the current collector member; an inner terminal plate located inside the cap plate and welded to the hollow type rivet; and an external terminal plate located outside the cap plate and welded to the hollow type rivet, wherein a thickness of the current collector member may be larger than a thickness of the hollow type rivet.

In one or more embodiments, the uncoated portion tabs may be located on upper and lower portions of the electrode assembly so as to be spaced apart from each other, and the sub-plate may include: a first sub-region electrically coupled to the current collector member and spaced apart from the electrode assembly; second sub-regions bent upward and downward, respectively, from the first sub-region and extending; and third sub-regions extending from the second sub-regions and welded to the uncoated portion tabs.

In one or more embodiments, the secondary battery may further include an elastic member between the first sub-region and the electrode assembly.

In one or more embodiments, the elastic member may include: a first elastic region in close contact with the electrode assembly; second elastic regions bent upward and downward, respectively, from the first elastic region and extending; and third elastic regions extending from the second elastic regions, respectively, to be in close contact with the first sub-region.

In one or more embodiments, the elastic member may include an electrical insulator.

In one or more embodiments, the elastic member may support the current collector member when the side terminal is welded to the current collector member.

In one or more embodiments, the secondary battery may further include an internal insulator between the cap plate and the sub-plate.

In one or more embodiments, the internal insulator may include a support protrusion between the cap plate and the electrode assembly to support the cap plate.

### BRIEF DESCRIPTION OF THE DRAWINGS

FIGS. 1A, 1B, and 1C are a perspective view, a cross-sectional view taken along the line 1b-1b of FIG. 1A, and a cross-sectional view taken along the line 1c-1c of FIG. 1A, respectively, illustrating a secondary battery according to an embodiment of the present disclosure.

FIGS. 2A to 2C are cross-sectional views illustrating a method for manufacturing a secondary battery according to an embodiment of the present disclosure.

FIGS. 3A to 3F are perspective views illustrating a method for manufacturing a secondary battery according to an embodiment of the present disclosure.

### DETAILED DESCRIPTION

Herein, some embodiments of the present invention will be described in further detail with reference to the accompanying drawings.

Some examples of the present invention are provided to more completely explain the present invention to those skilled in the art; however, the following examples may be modified in various other forms. That is, the present invention may be embodied in many different forms and should not be construed as being limited to the example embodiments set forth herein. Rather, these example embodiments are provided so that this disclosure will be thorough and complete and will convey the aspects and features of the present invention to those skilled in the art.

In addition, in the accompanying drawings, sizes or thicknesses of various components may be exaggerated for brevity and clarity. Like numbers refer to like elements throughout. As used herein, the term “and/or” includes any and all combinations of one or more of the associated listed items. In addition, it is to be understood that when an element A is referred to as being “connected to” an element B, the element A may be directly connected to the element B or one or more intervening elements C may be present therebetween such that the element A and the element B are indirectly connected to each other.

The terminology used herein is for the purpose of describing particular embodiments and is not intended to be limiting of the disclosure. As used herein, the singular forms are intended to include the plural forms as well, unless the context clearly indicates otherwise. It is to be further understood that the terms “comprise” and/or “comprising” when used in this specification, specify the presence of stated features, numbers, steps, operations, elements, and/or components, but do not preclude the presence or addition of one or more other features, numbers, steps, operations, elements, components, and/or groups thereof.

It is to be understood that, although the terms “first,” “second,” etc. may be used herein to describe various members, elements, regions, layers, and/or sections, these members, elements, regions, layers, and/or sections should not be limited by these terms. These terms are used to distinguish one member, element, region, layer, and/or section from another. Thus, for example, a first member, a first element, a first region, a first layer, and/or a first section discussed below could be termed a second member, a second element, a second region, a second layer, and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the example term “below” can encompass both an orientation of above and below.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

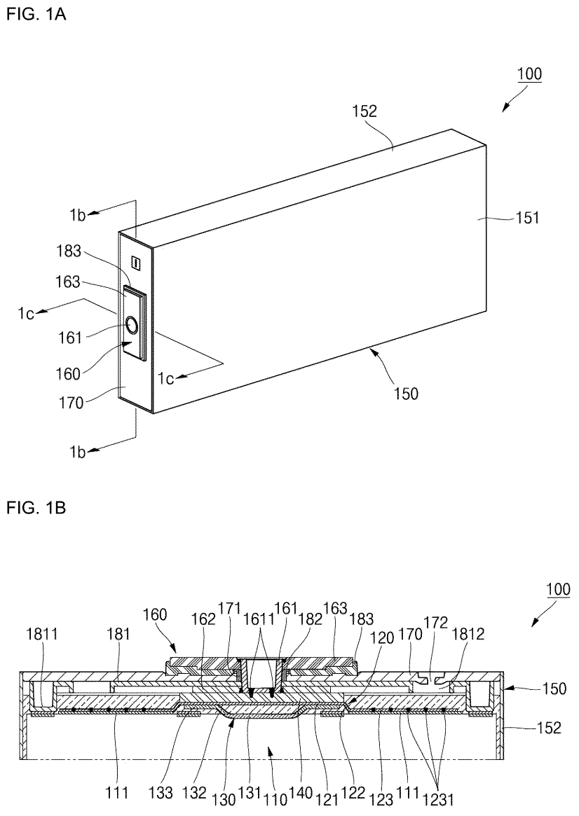

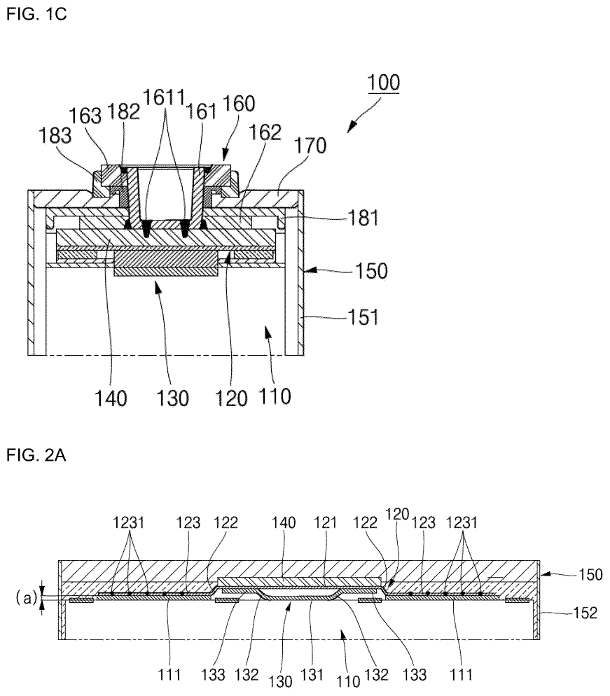

FIGS. 1A, 1B, and 1C are a perspective view, a cross-sectional view taken along the line 1b-1b of FIG. 1A, and a cross-sectional view taken along the line 1c-1c of FIG. 1A, respectively, illustrating a secondary battery according to an embodiment of the present disclosure. Here, FIGS. 1B and 1C show that the secondary battery shown in FIG. 1A is rotated clockwise by 90°, for convenience of explanation. Accordingly, the terms “upper” and “lower” in the following description may refer to “left” and “right.”

In the example shown in FIGS. 1A, 1B, and 1C, a secondary battery 100 according to an embodiment of the present disclosure may include an electrode assembly 110, a sub-plate 120, a current collector member 140, a case 150, a side terminal 160, and a cap plate 170. In some examples, the secondary battery 100 may further include an elastic member 130.

The electrode assembly 110 may be provided by stacking or winding a laminate of a negative electrode plate, a separator, and a positive electrode plate, which are in forms of thin plates or films. In other words, the electrode assembly 110 may be of a stack type or a winding type. In some examples, in the electrode assembly 110, two or more electrode assemblies may be positioned adjacent to each other.

In some examples, the negative electrode plate is provided by coating a negative electrode active material, such as graphite or carbon, on a negative electrode current collector made of a metal foil, such as copper, a copper alloy, nickel, or a nickel alloy, and may include a negative electrode uncoated portion tab (or a negative electrode tab) 111 that is a region to which the negative electrode active material is not applied. In some examples, the negative electrode uncoated portion tab 111 may be provided by cutting in advance to protrude laterally when manufacturing the negative electrode plate, and may be formed integrally with the negative electrode plate. In some examples, the negative electrode uncoated portion tab 111 may include approximately two negative electrode uncoated portion tabs 111 protruding in the lateral direction of the electrode assembly 110. In some examples, the negative electrode uncoated portion tabs 111 may be provided at upper and lower portions (or left and right in FIG. 1B), respectively, with respect to the electrode assembly 110.

In some examples, the positive electrode plate is provided by coating a positive electrode active material, such as a transition metal oxide, on a positive electrode current collector made of a metal foil, such as aluminum or an aluminum alloy, and may include a positive electrode uncoated portion tab (not shown) (or a positive electrode tab) that is a region to which the positive electrode active material is not applied. In some examples, the positive electrode uncoated tab may be provided by cutting in advance to protrude laterally when manufacturing the positive electrode plate, and may be formed integrally with the positive electrode plate. In some examples, the positive electrode uncoated portion tab may include approximately two positive electrode uncoated portion tabs protruding in the lateral direction of the electrode assembly 110. In some examples, the positive electrode uncoated portion tabs may be provided at upper and lower portions (or left and right in FIG. 1B), respectively, with respect to the electrode assembly 110. In some examples, the negative electrode uncoated portion tabs 111 and the positive electrode uncoated portion tabs may protrude in opposite directions.

In some examples, the separator is positioned between the negative electrode plate and the positive electrode plate to prevent or substantially prevent a short circuit and enable the movement of lithium ions, and may include polyethylene, polypropylene, or a composite film of polyethylene and polypropylene. In some examples, the separator may be replaced with an inorganic solid electrolyte, such as a sulfide-based, oxide-based, or phosphate-based electrolyte, which does not require a liquid or gel electrolyte.

In some examples, the electrode assembly 110 may be accommodated in the case 150 together with an electrolyte. In some examples, the electrolyte may include a lithium salt, such as LiPF₆ or LiBF₄, in an organic solvent, such as ethylene carbonate (EC), propylene carbonate (PC), diethyl carbonate (DEC), ethylmethyl carbonate (EMC), or dimethyl carbonate (DMC). In addition, the electrolyte may be in a liquid or gel phase. In some examples, when an inorganic solid electrolyte is used, the electrolyte may be omitted.

In some examples, a structure electrically connected to the positive electrode plate of the secondary battery 100 may be the same as or similar to a structure electrically connected to the negative electrode plate. Therefore, for convenience of explanation, the following description will focus on a structure electrically connected to the negative electrode plate.

The sub-plate 120 may be welded to the uncoated portion tabs (the negative electrode uncoated portion tabs) 111 of the electrode assembly 110. In some examples, since the uncoated portion tabs 111 may be provided spaced apart from each other on the upper and lower portions (right and left in FIG. 1B) with respect to the electrode assembly 110, the sub-plate 120 is also provided so as to correspond thereto.

In some examples, the sub-plate 120 may include a first sub-region 121, second sub-regions 122, and third sub-regions 123.

In some examples, the first sub-region 121 may be electrically coupled to the current collector member 140 and may be spaced apart from the electrode assembly 110 and the uncoated portion tabs 111.

In some examples, the second sub-regions 122 may be bent in upper and lower directions (right and left directions in FIG. 1B), respectively, on the basis of the first sub-region 121, to then extend. In some examples, the second sub-regions 122 may be bent from the first sub-region 121 toward the opposite uncoated portion tabs 111 to then extend.

In some examples, the third sub-regions 123 may extend from the second sub-regions 122, respectively, and may be welded to the uncoated portion tabs 111, respectively. In some examples, the third sub-regions 123 may be positioned parallel to the uncoated portion tabs 111. In this way, a plurality of welding regions 1231 may be provided between the third sub-regions 123 and the uncoated portion tabs 111. In some examples, the sub-plate 120 may include copper, nickel, aluminum, or stainless steel.

The elastic member 130 may be interposed between the first sub-region 121 and the electrode assembly 110. In some examples, the elastic member 130 may be positioned between the uncoated portion tabs 111 spaced apart from each other. In some examples, the elastic member 130 may include a first elastic region 131, second elastic regions 132, and one or more third elastic regions 133.

In some examples, the first elastic region 131 may be in close contact with the electrode assembly 110. In some examples, the first elastic region 131 may be in close contact with a partial region of the electrode assembly 110 between the uncoated portion tabs 111.

In some examples, the second elastic regions 132 may be bent from the first elastic region 131 in upper and lower directions (right and left directions in FIG. 1B), respectively, and extend. In some examples, the second elastic regions 132 may be bent from the first sub-region 121 to then extend.

In some examples, the second sub-regions 122 may be bent and extended from the first sub-region 121 toward the uncoated area tabs 111 on both sides.

In some examples, the one or more third elastic regions 133 may each extend from the second elastic regions 132 to be in close contact with the first sub-region 121, respectively.

In some examples, the elastic member 130 may generally have a cup shape, a saucer shape, or a “U” shape.

In some examples, the elastic member 130 may include an electric insulator. In some examples, the elastic member 130 may include polytetrafluoroethylene (PTFE), polyphenylene sulfide (PPS), polyphenylene (PP), or polyether ether ketone (PEEK) that does not react with an electrolyte.

In some examples, the elastic member 130 may support the current collector member 140 when the side terminal 160 is welded to the current collector member 140. Therefore, due to the elastic member 130, adhesion between the current collector member 140 and the side terminal 160 is improved, and, thus, welding quality can be improved.

The current collector member 140 may be electrically connected to the sub-plate 120. The current collector member 140 may be provided on the first sub-region 121 of the sub-plate 120. In some examples, the current collector member 140 may be integrated with the sub-plate 120 or may be provided separately to be coupled to the sub-plate 120. In some examples, a thickness of the current collector member 140 may be larger than that of the sub-plate 120 or the first sub-region 121. In some examples, the current collector member 140 may include copper, nickel, aluminum, or stainless steel.

The case 150 may include an opening provided in the lateral direction, and the electrode assembly 110 may be coupled through the opening. In some examples, the case 150 may have a rectangular parallelepiped shape in which openings are provided in the left side direction and the right side direction, respectively. In some examples, the case 150 may include a pair of long sides 151 and a pair of short sides 152 connecting the pair of long sides 151. In some examples, at least one safety vent, or notch, may be provided on the long sides 151 or the short sides 152. In some examples, the case 150 may include copper, nickel, aluminum, or stainless steel.

The side terminal 160 may be welded on the current collector member 140. In some examples, the side terminal 160 may include a hollow rivet 161, an inner terminal plate 162, and an outer terminal plate 163.

In some examples, the hollow rivet 161 may penetrate the cap plate 170 to then be welded onto the current collector member 140. In some examples, a bottom surface of the hollow rivet 161 may be welded to the current collector member 140. Accordingly, welding regions 1611 may be provided between the hollow rivet 161 and the current collector member 140. In some examples, the hollow rivet 161 may include a cup shape, a plate shape, or a “U” shape. In some examples, the hollow rivet 161 may include copper, nickel, aluminum, or stainless steel.

In some examples, the thickness of the current collector member 140 may be larger than a thickness of the side terminal 160, for example, the thickness of the hollow rivet 161 or the bottom surface of the hollow rivet 161. Therefore, when the hollow rivet 161 is welded to the current collector member 140, the current collector member 140 is not damaged. For example, if the thickness of the current collector member 140 is similar to or smaller than the thickness of the hollow rivet 161, only a through hole is formed by a laser beam during a welding process, but welding may not be performed.

The inner terminal plate 162 may be located inside the cap plate 170 and welded to the hollow rivet 161. In some examples, the inner terminal plate 162 may be in close contact with the current collector member 140. In some examples, the inner terminal plate 162 may include copper, nickel, aluminum, or stainless steel. In some examples, the outer terminal plate 163 may be located on the outside of the cap plate 170 and welded to the hollow rivet 161. In some examples, the outer terminal plate 163 may include copper, nickel, aluminum, or stainless steel.

In some examples, an internal insulator 181 may be interposed between the cap plate 170 and the sub-plate 120 (including the current collector member 140 and the inner terminal plate 162). Accordingly, an electrical short circuit between the cap plate 170 and the sub-plate 120 (including the current collector member 140 and the inner terminal plate 162) can be prevented or substantially prevented.

In some examples, a sealing insulator 182 may be interposed between the cap plate 170 and the hollow rivet 161. Accordingly, an electrical short circuit between the cap plate 170 and the hollow rivet 161 can be prevented or substantially prevented, and electrolyte leakage can be prevented or substantially prevented. In some examples, an external insulator 183 may be interposed between the cap plate 170 and the outer terminal plate 163. In some examples, the insulators 181, 182, and 183 may include polytetrafluoroethylene (PTFE), polyphenylene sulfide (PPS), polyphenylene (PP), or polyether ether ketone (PEEK) that does not react with an electrolyte. In some examples, a highly resistant member (e.g., a member having resistance of 1 MΩ or more), instead of the external insulator 183, may be interposed between the cap plate 170 and the outer terminal plate 163. Accordingly, the side terminal 160, the cap plate 170, and the case 150 may have a same polarity.

In some examples, the internal insulator 181 may further include a support protrusion 1811 interposed between the cap plate 170 and the electrode assembly 110 to support the cap plate 170. In some examples, the support protrusion 1811 may be provided in a region close to the short side 152 of the case 150.

Accordingly, when the cap plate 170 is welded to the case 150, the welding process may be performed in a state in which the periphery of the cap plate 170 is stably supported by the support protrusion 1811.

The cap plate 170 passes through the side terminal 160 and may be coupled to the opening of the case 150. The cap plate 170 may include a terminal hole 171, and the hollow rivet 161 of the side terminal 160 may pass through the terminal hole 171. As described above, the sealing insulator 182 may be interposed between the hollow rivet 161 and the inner wall of the terminal hole 171 of the cap plate 170. In some examples, the cap plate 170 may include an injection hole 172 for injecting an electrolyte. In some examples, an injection plug may be coupled to the injection hole 172. In some examples, injection holes 1812 may also be provided in the internal insulator 181 corresponding to the injection hole 172. In some examples, injection holes 1812 are provided at opposite sides of the internal insulator 181, such that a battery assembling process can be facilitated, regardless of an input direction of the internal insulator 181.

In some examples, the cap plate 170 may be welded (e.g., by laser welding) to the case 150 along a periphery of the cap plate 170. In some examples, the cap plate 170 may include copper, nickel, aluminum, or stainless steel.

As described above, another side terminal (not shown) provided at the rear, or right side, of the secondary battery 100 (e.g., a positive side terminal) and peripheral structures thereof (e.g., a sub-plate, a current collector member, etc.) may be similar to or the same as the above-described side terminal 160 and peripheral structures thereof, and, thus, further description thereof will be omitted.

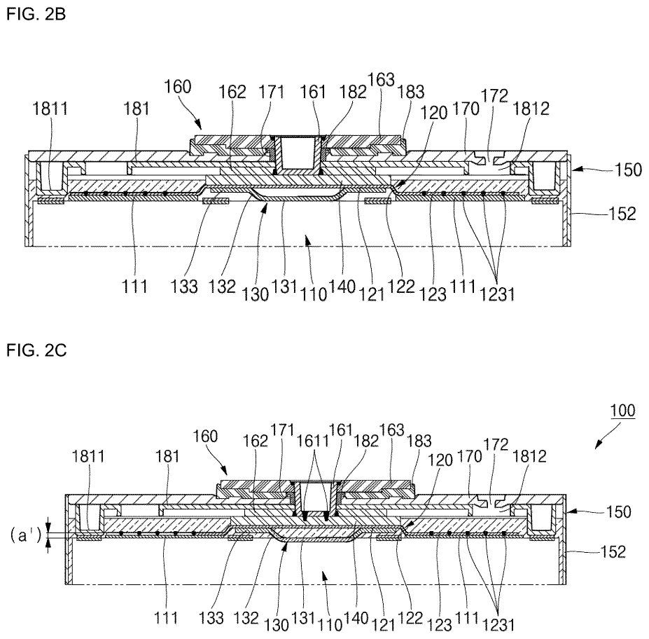

FIGS. 2A to 2C are cross-sectional views illustrating a method for manufacturing the secondary battery 100 according to an embodiment of the present disclosure.

As shown in FIG. 2A, after the elastic member 130 and the sub-plate 120 are attached to the electrode assembly 110, the electrode assembly 110 may be coupled to the case 150. In some examples, after the sub-plate 120 is welded to the electrode assembly 110, the electrode assembly 110 may be coupled to the case 150. In some examples, the current collector member 140 may be attached to the sub-plate 120 in advance. In some examples, the third sub-regions 123 of the sub-plate 120 may be laser-welded to each of the uncoated portion tabs 111. After the laser welding process, a plurality of welding regions 1231 may be provided between the third sub-regions 123 of the sub-plate 120 and the uncoated portion tabs 111. In some examples, a gap (or a height of the uncoated portion tabs 111) between the sub-plate 120 and the top of the electrode assembly 110 may be defined as “a.” In some examples, the elastic member 130 may not be pressed while the sub-plate 120 and the uncoated portion tab 111 are welded to each other.

As shown in FIG. 2B, the cap plate 170 to which the side terminal 160 is coupled may be coupled to the case 150. In some examples, the hollow rivet 161 of the side terminal 160 and the inner terminal plate 162 may be in close contact with the current collector member 140. In some examples, the support protrusion 1811 of the internal insulator 181 coupled to the inner surface of the cap plate 170 may be in close contact with the electrode assembly 110. In some examples, the periphery of the cap plate 170 may be in close contact with the opening of the case 150. In some examples, the periphery of the cap plate 170 may be in close contact with the long sides 151 and the short sides 152 of the case 150.

As shown in FIG. 2C, in a state in which the side terminal 160 and the cap plate 170 are pressed toward the electrode assembly 110, the side terminal 160 may be laser-welded to the current collector member 140. In some examples, the bottom surface of the hollow rivet 161 of the side terminal 160 may be laser-welded on the current collector member 140. During the laser welding process, the elastic member 130 may be pressed. In other words, as the elastic member 130 is pressed during the welding process, the adhesion between the hollow rivet 161 and the current collector member 140 is improved, thereby improving the laser-welding quality between the hollow rivet 161 and the current collector member 140. In some examples, a plurality of welding regions 1611 may be provided between the hollow rivet 161 and the current collector member 140 after the welding process is completed. In some examples, after the laser welding process, a gap (or a height of the uncoated portion tab 111) between the sub-plate 120 and the top end of the electrode assembly 110 may be defined as a′, and a′ may have a small numerical range. In some examples, after the laser welding process, the height (or thickness) of the uncoated portion tabs 111 may be reduced (e.g., the gap a′ after laser welding becomes smaller than the gap “a” before laser welding).

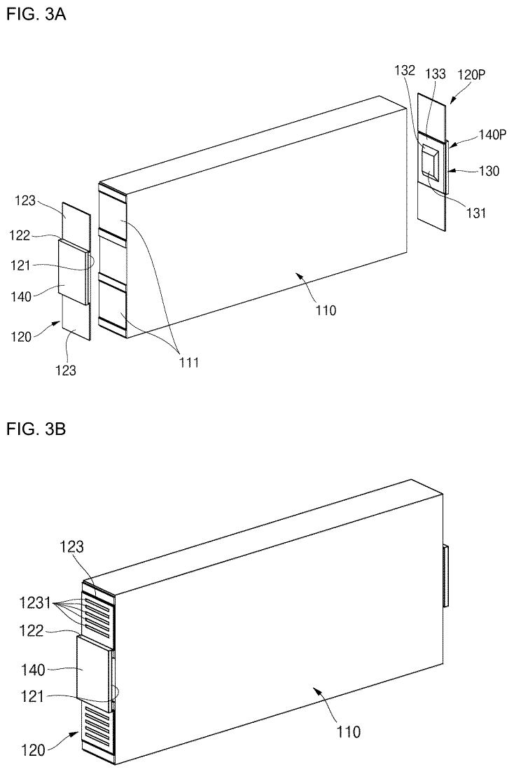

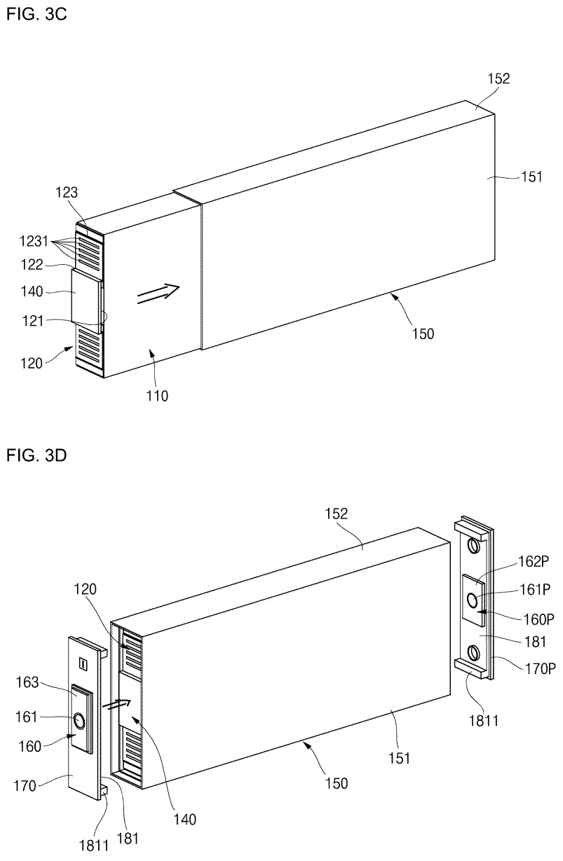

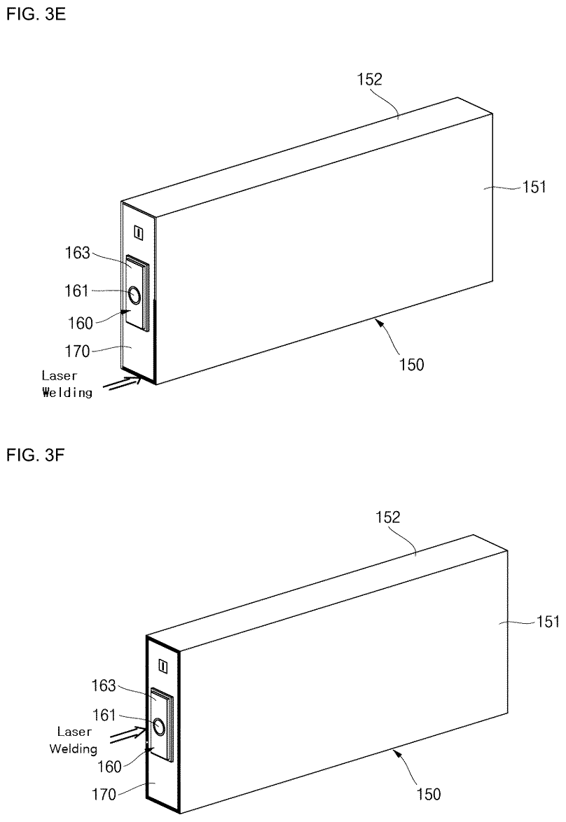

FIGS. 3A to 3F are perspective views illustrating a method for manufacturing the secondary battery 100 according to an embodiment of the present disclosure.

As shown in FIGS. 3A and 3B, sub-plates (including current collector members) may be welded to the front and rear (i.e., left and right) sides of the electrode assembly 110, respectively. In some examples, a negative electrode sub-plate 120 (including the negative current collector member 140) may be welded to the negative electrode uncoated portion tab 111 provided on the front side (left side) of the electrode assembly 110, and a sub-plate 120P (a positive current collector member 140P) may be welded to a positive electrode uncoated portion tab (not shown) provided on the rear side (right side) of the electrode assembly 110. In some examples, welding may be performed by a laser welding process. Accordingly, a plurality of welding regions 1231 may be provided in the third sub-regions 123 of the sub-plate 120. In some examples, an elastic member (not shown) may be interposed between the negative sub-plate 120 and the front side of the electrode assembly 110, and another elastic member 130 may be interposed between the positive sub-plate 120P and the rear side of the electrode assembly 110.

In some examples, the elastic member 130 may include a centrally disposed first elastic region 131, second elastic regions 132 that are bent in the upper and lower directions of the first elastic region 131 to then extend, and a third elastic region 133 that is spaced apart from the first elastic region 131 to be positioned in a rectangular ring shape and is connected to the second elastic regions 132.

As shown in FIG. 3C, the electrode assembly 110 to which the negative electrode sub-plate 120 and the positive electrode sub-plate (not shown) are welded may be coupled to the case 150. In some examples, the electrode assembly 110 may be coupled to the case 150 in the lateral direction through an opening provided in the case 150. In some examples, the electrode assembly 110 may be in close contact with inner walls of the long sides 151 and the short sides 152 of the case 150.

As shown in FIG. 3D, a negative-electrode cap plate 170 to which a negative-electrode side terminal 160 is assembled and a positive-electrode cap plate 170P to which a positive-electrode side terminal 160P is assembled may be coupled to the front and rear sides of the electrode assembly 110, respectively. In some examples, in the negative-electrode side terminal 160, the hollow rivet 161 and the inner terminal plate 162 may be in close contact with the negative current collector member 140. In addition, in the positive-electrode side terminal 160P, a hollow rivet 161P and an inner terminal plate 162P may be in close contact with the positive current collector member 140P.

As shown in FIG. 3E, a periphery of the negative-electrode cap plate 170 may be laser-welded to the front of the case 150, and a periphery of an anode-side cap plate (not shown) may be laser-welded to the rear of the case 150. In other words, the periphery of the cap plate 170 may be laser-welded to the long sides 151 and the short sides 152 of the case 150.

As shown in FIG. 3F, the negative-electrode side terminal 160 may be laser-welded to the negative current collector member 140, and a positive-electrode side terminal (not shown) may be laser-welded to the positive current collector member 140P. In some examples, the bottom surface of the negative-electrode hollow rivet 161 may be laser-welded onto the negative-electrode current collector member 140, and the bottom side of a positive-electrode hollow rivet (not shown) may be laser-welded onto the positive current collector member 140P. The laser welding process may be performed in a manner similar to that shown in FIGS. 2A to 2C.

In this way, the present disclosure provides the secondary battery 100 having the side terminal 160.

In addition, according to embodiments of the present disclosure, since terminals of the secondary battery 100 are provided in the left region and the right region, respectively, battery cooling can be performed concurrently (e.g., simultaneously) in the upper region and the lower region, thereby improving battery cooling efficiency. Conventionally, since all terminals are provided on the upper part of a secondary battery, it is difficult to cool the upper region of the secondary battery.

In addition, according to embodiments of the present disclosure, compared to a secondary battery in which two terminals are provided in the upper region, a terminal is provided in each of the left region and the right region, thereby improving space utilization. Conventionally, since all terminals are provided on an upper portion of a secondary battery, the space utilization rate for the upper region of the secondary battery is reduced.

In addition, according to the present disclosure, since terminals are respectively arranged in the horizontal direction in the left and right regions, charge/discharge current may flow in the horizontal direction, and thus battery deterioration may be reduced. Conventionally, as all terminals are provided on the upper portion of a secondary battery, there would be a problem in that a specific area of the secondary battery may be rapidly deteriorated as the charge/discharge current flows in an approximately “U”-shaped path.

As described above, embodiments of the present disclosure provide a secondary battery having a side terminal. In addition, according to embodiments of the present disclosure, since terminals of the secondary battery are provided in left and right regions, respectively, battery cooling can be concurrently (e.g., simultaneously) performed in upper and lower regions, thereby improving cooling efficiency. In addition, compared to a secondary battery in which two terminals are provided in the upper region, according to embodiments of the present disclosure, a terminal is provided in each of the left and right regions, thereby improving space utilization. In addition, according to embodiments of the present disclosure, since the terminals are respectively arranged in the horizontal direction in the left region and the right region, the charge/discharge current may flow in the horizontal direction (i.e., in a straight direction), and, thus, battery deterioration may be reduced.

While one or more embodiments have been described herein, the present disclosure is not limited thereto, and it will be understood by a person skilled in the art that various changes in form and details may be made therein without departing from the spirit and scope of the present disclosure as set forth in the following claims.

What is claimed is:

1. A secondary battery comprising:
an electrode assembly comprising uncoated portion tabs;
a sub-plate welded to the uncoated portion tabs;
a current collector member electrically connected to the sub-plate;
a case having an opening and coupling the electrode assembly through the opening;
a terminal welded on the current collector member; and
a cap plate through which the terminal passes, the cap plate coupled to the opening.

2. The secondary battery of claim 1, wherein a thickness of the current collector member is larger than a thickness of the terminal.

3. The secondary battery of claim 1, wherein the terminal comprises: a hollow type rivet penetrating through the cap plate and welded on the current collector member; an inner terminal plate located inside the cap plate and welded to the hollow type rivet; and an external terminal plate located outside the cap plate and welded to the hollow type rivet, wherein a thickness of the current collector member is larger than a thickness of the hollow type rivet.

4. The secondary battery of claim 3, further comprising a sealing insulator between the hollow type rivet and the cap plate.

5. The secondary battery of claim 3, further comprising an internal insulator between the inner terminal plate and the cap plate.

6. The secondary battery of claim 3, further comprising an external insulator between the external terminal plate and the cap plate.

7. The secondary battery of claim 3, wherein the inner terminal plate contacts the current collector member.

8. The secondary battery of claim 1, wherein the sub-plate comprises: a first sub-region electrically coupled to the current collector member and spaced apart from the electrode assembly; second sub-regions bent in an opposite direction, respectively, from the first sub-region and extending; and third sub-regions extending from the second sub-regions and welded to the uncoated portion tabs.

9. The secondary battery of claim 8, further comprising an elastic member between the first sub-region and the electrode assembly.

10. The secondary battery of claim 9, wherein the elastic member comprises: a first elastic region in contact with the electrode assembly; second elastic regions bent in an opposite direction, respectively, from the first elastic region and extending; and third elastic regions extending from the second elastic regions, respectively, to be in close contact with the first sub-region.

11. The secondary battery of claim 10, wherein as the second elastic regions are spaced apart from the first elastic region, a spacing between the second elastic regions increases.

12. The secondary battery of claim 9, wherein the elastic member comprises an electrical insulator.

13. The secondary battery of claim 9, wherein the elastic member supports the current collector member when the terminal is welded to the current collector member.

14. The secondary battery of claim 8, wherein as the second sub-regions are spaced apart from the first sub-regions, a spacing between the second sub-regions increases.

15. The secondary battery of claim 1, further comprising an internal insulator between the cap plate and the sub-plate.

16. The secondary battery of claim 15, wherein the internal insulator comprises a support protrusion between the cap plate and the electrode assembly.

17. The secondary battery of claim 16, wherein the support protrusion supports the cap plate when the cap plate is welded to the case.

18. The secondary battery of claim 16, wherein the support protrusion presses the electrode assembly on an outside of the sub-plate.

19. The secondary battery of claim 15, wherein the cap plate further comprises a cap plate injection hole, and the internal insulator further comprises an internal insulator injection hole in an area corresponding to the cap plate injection hole.

20. The secondary battery of claim 1, wherein the sub-plate and the current collector member are provided integrally or are provided separately and joined to each other.

21. The secondary battery of claim 1, wherein the uncoated portion tabs are spaced apart in opposite directions from a center of the electrode assembly.
